(19) United States
(12) Patent Application Publication
(10) Pub. No.: US 2021/0153496 A1
(43) Pub. Date: May 27, 2021

(54) Weed Killing Apparatus Using Radio Frequency Energy and Matching Circuits

(71) Applicant: Thomas Holtzman Williams, Longmont, CO (US)

(72) Inventor: Thomas Holtzman Williams, Longmont, CO (US)

(21) Appl. No.: 16/695,628

(22) Filed: Nov. 26, 2019

(51) Int. Cl. A01M 21/04

(52) U.S. Cl. CPC A01M 21/046

(57) ABSTRACT

A week killing device where weeds or other undesirable vegetation are killed by radio frequency (RF) energy applied directly to the weed by a probe inserted into or near the weed. The probe is comprised of a center pin, which is electrically hot, surrounded by periphery pins which are grounded. A reflection measuring circuit makes an impedance measurement of the probe in the ground and a matching circuit is adjusted to make an impedance match. Next a RF generator applies RF energy through the matching circuit into the probe. Energy delivery is monitored to insure weed kill by thermal heating. The probe can be manually applied by a person or applied by an autonomous vehicle using computer vision (CV) and artificial intelligence (AI) to identify weeds and avoid row crops. The weed killing device may apply power to the above-ground portion a of a weed with the root providing a ground return. The weed killing device may be towed and apply RF energy when a weed is detected by the impedance measurement circuit.

### Cross reference to Related Applications

This application claims benefit and priority of U.S. Provisional Patent Application Ser. No. 62/917,190 filed Nov. 26, 2018. The disclosures of this application are incorporated herein by reference in their entireties.

### BACKGROUND

The field of the disclosure relates generally to agricultural equipment and more particularly to devices to kill undesired plant growth.

Current agricultural practice is to genetically modify plants (a.k.a. GMO, or genetically modified organisms) to resist certain herbicides, and then broadcast spray a field with a herbicide, such as Dicamba or glysophate a.k.a. Roundup(R). This creates at least four problems. First, the crop has been modified from what humans are adapted to using genetic modification, causing digestion and allergy problems with a percentage of individuals in a population. Second, the crop and the environment are polluted with the herbicide. Third, the weeds adapt to the herbicide so that it is no longer effective, causing new species and new herbicides to be created. Fourth, the GMO plants spread their DNA into non-GMO plants, polluting those plant strains as well.

Organic farming has many advantages, but weeds compete with farm crops for space, light, nutrients, and water. Weeds also plug harvesting machinery, and contaminate the crops, such as wild rye seeds in harvested wheat. There is a need to kill weeds organically. On a small plot of soil, weeds can be manually pulled, but depending on soil looseness and weed species, some weeds just break off, growing back from the remaining root. On a large plot area, such as organic farmland, automated vehicles using AI (artificial intelligence) and computer vision can drive a field to kill weeds automatically.

Healthy soil has an ecosystem comprised of bacteria, fungus, and animal life, such as worms. It is a point of this invention to do a minimum of damage to an ecosystem while killing weeds. Note that generally weed is defined as any undesirable growth, so if you are growing soybeans, corn is a weed. In some applications, an invasive or non-native species could be considered a weed for extermination.

Other prior art solution to kill plants with electricity have used lethal voltage and have encountered problems with a large variation of soil conductivity, even within a same field.

Energy delivery is also an problem, where too much heat delivered into the soil is inefficient, and too little results in not killing the weed. Some organic systems apply intense laser light to kill the weed, but the light will not reach the root deep underground. Radio frequency energy is used to kill tumors in cancer victims. This process is called radio frequency ablation.

Prior art systems use AI/vision systems to limit herbicide application to just an identified weed.

Soil conductivity has two components, conductance and permittivity. Generally, soil has some resistive component and some reactive component, generally capacitive. Furthermore, these components vary with frequency, moisture content, soil type, salinity, PH, and compaction. When soil is probed, it has a complex impedance with a real and an imaginary part, or the measurement can be described as having a magnitude with a phase angle.

### SUMMARY

A system for killing weeds with heat is comprised of a RF (radio frequency) generator, a matching circuit, and a probe inserted into soil. An impedance measuring circuit measures the impedance of the probe in the soil, and the matching circuit is tuned. After an impedance match is made between the RF generator and the probe, sufficient RF energy is delivered by the generator through the matching circuit to the probe to kill the weed.

### DESCRIPTION OF FIGURES

FIG. 1 is a diagram of a weed being dispatched with a plant killing device using heat created by a RF power source.

FIG. 2 is an illustration of a probe for killing weeds.

FIG. 3 is an electrical diagram of weed killer.

FIG. 4 is a flow diagram of a weed killer.

FIG. 5 is a system diagram illustrating a weed killer, a vehicle to transport it, and an AI system to determine where to insert the probe.

FIG. 6 is a flow diagram used by an autonomous vehicle to kill weeds with thermal energy.

FIG. 7 is an illustration of a towed vehicle for killing weeds with an above ground contactor plate and grounding supplied by metal wheels.

FIG. 7A is a cross-sectional view of the towed vehicle of FIG. 7.

FIG. 8 is a flow diagram for the towed vehicle.

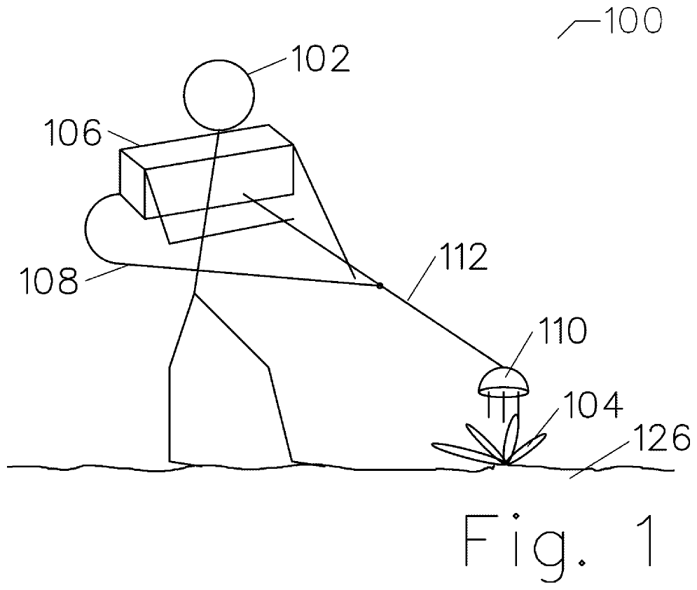

Description FIG. 1

FIG. 1 is a diagram of a person 102 killing a weed 104 with a plant killing device 112. A power pack and circuit box 106 on his/her back is connected thru a cable 108 to a probe 110. After the probe is inserted into the soil 126, a probe impedance measurement is made, a matching circuit is adjusted, and RF energy is applied to kill the weed. Power monitoring is used to time the heat application to insure correct heat (Joule) delivery.

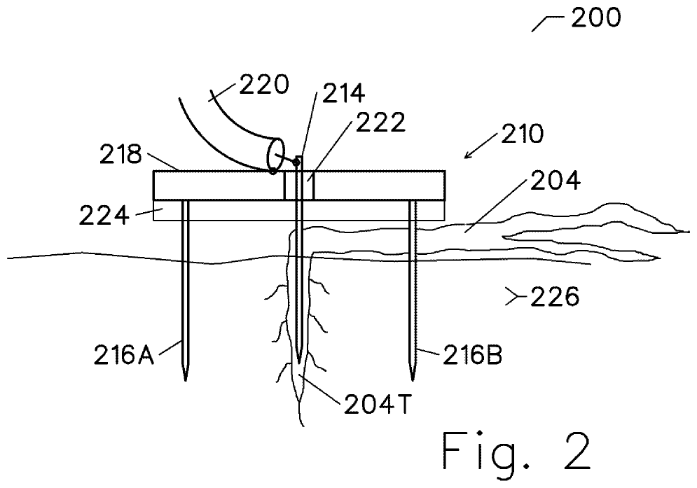

Description FIG. 2

FIG. 2 is a diagram 200 of a probe 210 inserted into weed 204. The probe is comprised of a center pin 214 and a plurality of periphery pins 216a, 216b mounted in a conductive mounting plate 218. A cable 220 connects to the center pin. An RF connector (not illustrated) may be employed, but it is optional. A center pin insulator 222 maintains high resistance between the center pin and the mounting plate. A center pin, which may be a tungsten rod such as are used in TIG (tungsten inert gas) welders, may be used for the center pin due to their high strength, even when hot. Other materials may alternately be used for the center pin. Due to skin-effect, the center pin may be plated with a highly conductive metal to reduce electrical losses. If desired, the center pin or periphery pins may be spring loaded (not illustrated) to avoid breakage or bending if a rock is encountered in the soil. Optionally, insulating material may be placed on the outside of a portion of the pin. For example, this could be done to apply RF energy deep into the root. Not illustrated is a mounting connection which is used to drive the probe into the soil and remove it after weed destruction.

On the soil, the weed is compressed by an optional insulating plate 224 situated below the mounting plate. The center pin penetrates the weed, and periphery pins penetrate the soil surrounding the center pin. It is desirable to penetrate the weed's tap root with the center probe to use conductivity of the tap root for conducting RF current deep into the weed's root. The tap root contains moisture, generally making the tap root 204T more conductive than surrounding soil. AC current flow is from the center pin through the weed to the periphery pins. Current density is highest around the center pin, so that is where the heat application will be the greatest.

The soil has a complex impedance comprised of resistance and reactance, determined by both soil conductance and permittivity, which are influenced by the soil type, moisture, temperature, compaction, and salinity. The center probe's location and characteristics of the weed will also influence the impedance.

The optional insulator plate 224 is located on the bottom of the probe mounting plate. It functions to keep the surface of the soil from shunting the current from the center pin to the mounting plate. It can also function as a center pin and periphery pin cleaner if the pins are retracted through the insulator plate.

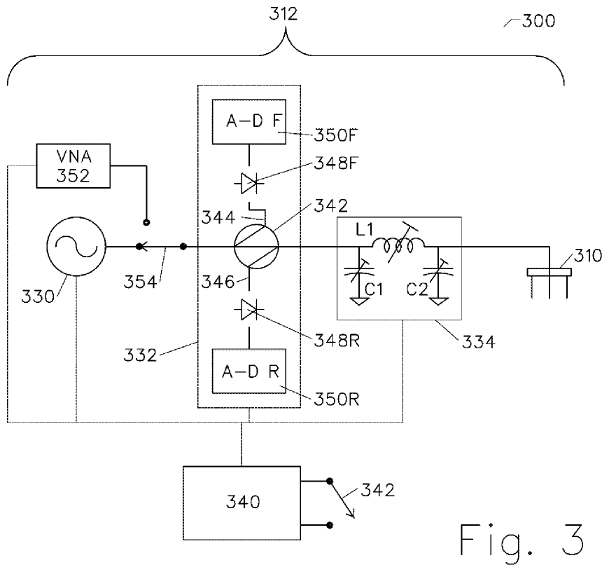

Description FIG. 3

FIG. 3 is a block diagram of 300 a weed killer 312, showing an RF generator 330, a bidirectional watt meter 332, a matching circuit 334, and the probe 310. An impedance measuring device used for measuring probe impedance may be a Vector Network Analyzer (VNA) device 352 which is known in the art. While the probe's impedance is being measured, the RF switch 354 is connected to the VNA, and while applying RF energy, the switch 354 is connected to the generator 330. The bidirectional watt meter functions to measure VSWR (voltage standing wave ratio) with is a ratio of forward power to reflected power, as well as to determine how much heat has been absorbed by the weed and surrounding soil. These components are controlled by a computer or microcontroller 340. After sticking a probe into the weed, the operator clicks a switch 342, telling the computer to measure impedance, adjust matching circuit if needed, and initiate a weed kill.

Generally, Ham radio transmitters technology can be applied to kill weeds, but the Ham transmitter's (generator) clean RF power, wide frequency agility, and frequency stability are not required for killing weeds. Furthermore, a Ham transmitter is relatively inefficient relative to a device that generates power with harmonics.

The RF generator may use a switching design for higher efficiency, although a linear amplifier may be used for test purposes. The frequency range is anticipated to be in the 0.1 to 100 MHz range. If frequency is too low, component size, weight, and cost increase. If frequency is too high switching losses increase. However, using magnetrons, as used in microwave ovens at 2.4 GHz, is also anticipated. The magnetron's drawback is a dangerous high voltage power supply is required. A solid-state RF generator should nominally draw approximately 50 amps at 50 volts DC.

When killing weeds, speed matters, particularly when an autonomous vehicle is working a large field. Delivered RF power is expected to be nominally around 1-2 kilowatts. Using excessive power may cause the weed to explode before being killed by cell death (cooking or blanching). Using too little power will require a high cook time to achieve vegetation-lethal temperatures, which is unproductive. For example, if a weed is assumed to be mostly comprised of water, its heat capacity will be around 4.2 Joules per degree C. per gram. That means one gram of water increases 238 degrees in one second with one kilowatt of heat application, and 25 grams of weed increases 19.4 degrees per second. If you need a 40 degree C. rise to kill the 25-gram weed, you need to apply this kilowatt of RF power for slightly over 2 seconds.

The wattmeter 332 is connected to the RF generator, and it can read both forward and reflected power. Watt meters can be purchased a Ham radio store and generally contain a directional coupler with a rectifier diode, producing a DC voltage proportional to RF energy squared. In is important to monitor the RF power in the forward direction to monitor heat applied to the soil. It is important to monitor RF power in the reflection direction to avoid damaging the RF generator with reflected power. Reflected power must be subtracted from forward power to determine power delivered. VSWR (voltage standing wave ratio) is a measure of how good the impedance match is, where 1.0 is ideal, meaning no reflected power. One exemplary implementation of a directional watt meter is comprised of a ferrite directional coupler 342 with a forward output 344 lead and a reflected output lead 346. Rectifier diodes 348F and 348R, which may be 1N5711 Schottky diodes, rectify the AC RF energy to produce DC voltage values, and analog to digital converters A-D_{F} and A-D_{R} converters to convert the rectified voltages into DC values, indicative of forward and reflected power. The computer 340 monitors the DC voltages while RF power is being applied.

A matching circuit 334 coupled between the wattmeter and the probe matches the impedance of the probe to the RF generator. A matching impedance of a source may be a complex conjugate of a matching impedance of the load, which is the probe in the ground. The matching circuit should use high-Q reactive components (inductors and capacitors), absorb a minimum of energy, and minimize back energy going to the RF generator. Illustrated is a PI section matching circuit with a tunable input capacitor C1, a tunable inductor L1, and a tunable output capacitor C2. The computer controls the adjustment of tunable components. Also anticipated are TEE section matching circuits, as well as L-section matching circuits. With L-section matching circuits, the shunt and series elements can be inductive or capacitive. Servo or stepper motors can mechanically adjust the elements while the VNA 352 is monitoring the impedance.

The American Radio Relay League (ARRL) Handbook contains information about designing matching circuits, and matching circuits can be purchased from Ham equipment manufacturers such as MFJ Enterprises in Starkville, Miss. Historically, Smith Charts have be used to manually choose matching components, but computer algorithms are now available. Automatic-tuning antenna matchers can be purchased. Tuning can be done by adjusting inductors and capacitors, or having relays switch in the desired values of fixed inductance and capacitance. Once a probe impedance has been measured, a lookup table can be used to produce ideal matching component values. Matching range for killing weeds will need to have a wider impedance range than is generally needed for Ham antennas. For example, dry sand will have a very high impedance, while salty marsh ground will have a low impedance. Generally matching can be done with a PI (illustrated), a TEE circuit, or L-section with tuning of elements to improve match. Other matching circuits can use transformers, resonant circuits with tapped inductors, resonant circuits with tapped capacitors, stubs, or transmission lines. Generally, the match needs only be good at the frequency used by the RF generator, but power loss by the matching circuit should be kept low for efficient operation. If a match cannot be achieved, perhaps because the probe is stuck in an aluminum beverage can, the weed kill is aborted for that location to protect the RF generator 330.

The impedance measuring circuit may be a VNA 352. Vector Network Analyzers are well-known in the art. Sometimes measured impedance is described using S-parameters, such as S11, a complex reflection coefficient. Low cost VNAs, as used for HAM antenna matching, are available. VNAs measuring impedance generally consist of a low power oscillator, a return loss bridge and a complex demodulator producing both In-phase and Quadrature (I-Q) DC voltages at each tuned frequency, which is known in the art. However, only half of a complex demodulator can be used if two DC voltages measurements are made. This is accomplished by measuring an In-phase voltage with oscillator producing a zero-degree signal into the mixer's local oscillator port. Next, with the oscillator producing a 90-degree signal into the mixer's local oscillator port, the quadrature voltage is measured. Swept measurements are generally not required if weeds are killed with a single frequency. An integrated circuit numerically controlled oscillator (NCO) capable of producing both zero and 90-degree outputs is the Analog Devices AD9851.

Common practice is to match the generator's complex-conjugate impedance to the load impedance, per the well-known Maximum Power Transfer Theorem. However, this results in an undesirable 50% power loss inside the generator. A more efficient method is to use a generator with a low source resistance, such as 10 ohms impedance and connected to a higher resistive matched load impedance, such as 50 ohms. Again, a switching-type RF generator should provide higher efficiency.

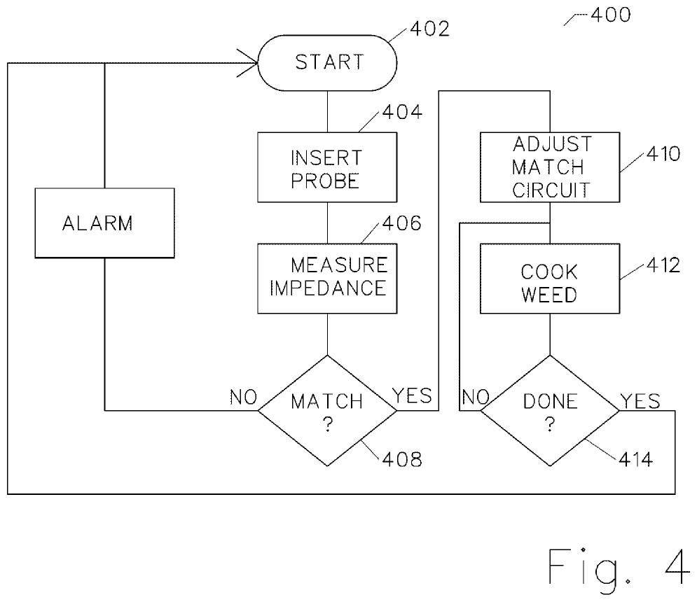

Description FIG. 4

FIG. 4 is a flow diagram 400 of a manually transported weed killer. In a first step 402 a weed has been identified, the switch 342 has been pressed and the process starts. In a second step 404 the probe is inserted into the weed. In a third step 406 the impedance is measured by the VNA. In a fourth step 408 a match is computed, if possible. If not, a fail alarm is sounded, and processing returns to start. If a match solution is found the matching circuit is programmed in a fifth step 410. In a sixth step 412 the power is applied for necessary time to cook (kill by heat) the weed. In a seventh step 414 a finished sound is made, and processing resumes at start.

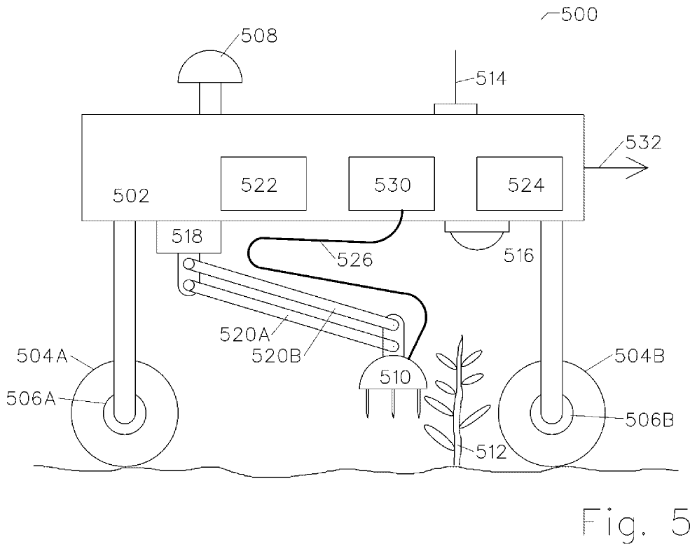

Description FIG. 5

FIG. 5 is a diagram 500 of an autonomous vehicle or semi-autonomous vehicle. It consists of a platform 502 and a plurality of steerable powered wheels 504A, 504B suitable for operation in a field, which could be muddy, hilly, or have obstacles. Nominally 3 or 4 wheels will be used. Propulsion is provided by hub motors 506A, 506B. Mounted on the top of the vehicle is a GPS receiver 508 which is connected to a vehicle computer 522. The GPS receiver may have a local reference point near the field to increase accuracy. Currently achievable position accuracy is 1-2 cm. Also mounted on the vehicle is a camera 516 connected to the computer 522, which processes images to locate weeds 512, along with their exact location. A Wi-Fi or other transceiver 514 is also located on the vehicle and used to interconnect to a network, providing connectivity with a central server to exchange information such as current location, progress, percentage successful, weather conditions, power supply, fault conditions, human interaction, etc.

Also mounted on the vehicle is a power supply and motor controller 524. Power may be supplied by a rechargeable battery, optionally assisted by solar cells or a petroleum or other motor.

The probe 510 is mounted on arm 520 comprised of links 520A and 520B which swing up and down. The arm is mounted on a rotary hub 518 which rotates the arm and probe from left to right relative to the direction of vehicle motion 532. A cable 526 attaches the probe to a weed killer in box 530 containing the matching circuit, which is connected to the bidirectional wattmeter, which is connected the RF generator. Alternately, more components, such as the matching circuit, may be located on the probe. A light, not illustrated, allows the system to operate at night. If a row crop is being processed, the wheels roll between rows. The vehicle, under computer control, travels down a row, killing weed after weed as rapidly as possible. The computer controls all aspect of vehicle operation, including propulsion, power management, communication, etc.

The arm's links may be actuated with pneumatic, hydraulic, or electrically, such as with servo motors, stepper motors, or solenoids.

Another anticipated embodiment is an arm that, in addition to moving the probe up and down and right and left, can also move it forward and backwards. This mechanism will allow the vehicle to move at constant speed while a weed is being cooked. This could be accomplished, for example, by mounting rotary hub 518 on a rail (not illustrated) disposed in the direction of the vehicle's travel.

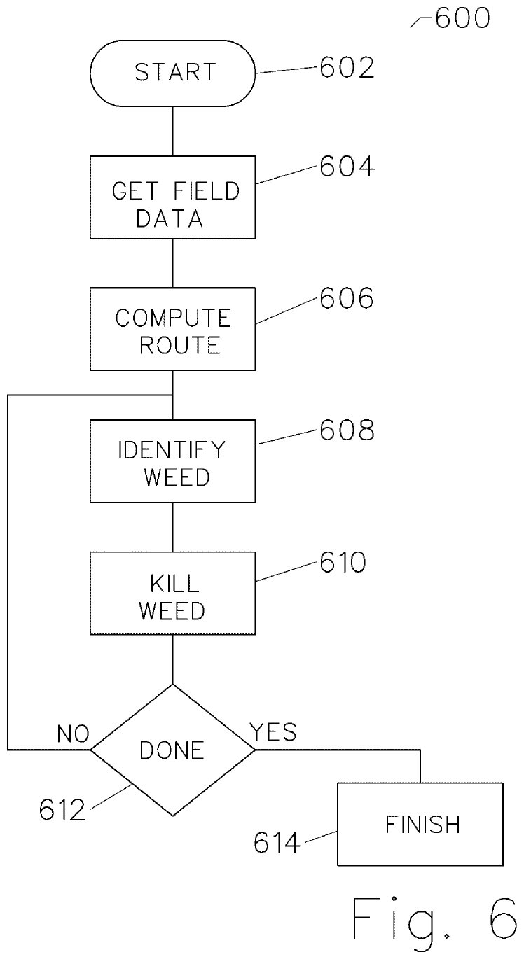

Description FIG. 6

FIG. 6 is a flow diagram 600 used by an autonomous vehicle. After a start 602, in a first step 604 the computer is given field data including the latitudes and longitudes of a field to be processed, along with obstacles to avoid, such as ditches and swamps. It is also programmed with the crop to avoid and the weed(s) to kill. In a second step 606 the computer then computes a travel path. In a third step 608 the computer processing an image from the camera to identify weeds. In a fourth step it kills an identified weed by inserting the probe into ground, measuring impedance, tuning the matching circuit, applying RF energy, and waiting for critical energy delivery. After energy delivery, the probe is removed the computer checks if the field is finished in a fifth step 612, and if not the vehicle/probe moves to the next weed. This loop continues until the field is completed. After the field is finished, processing is completed at a finish step 613

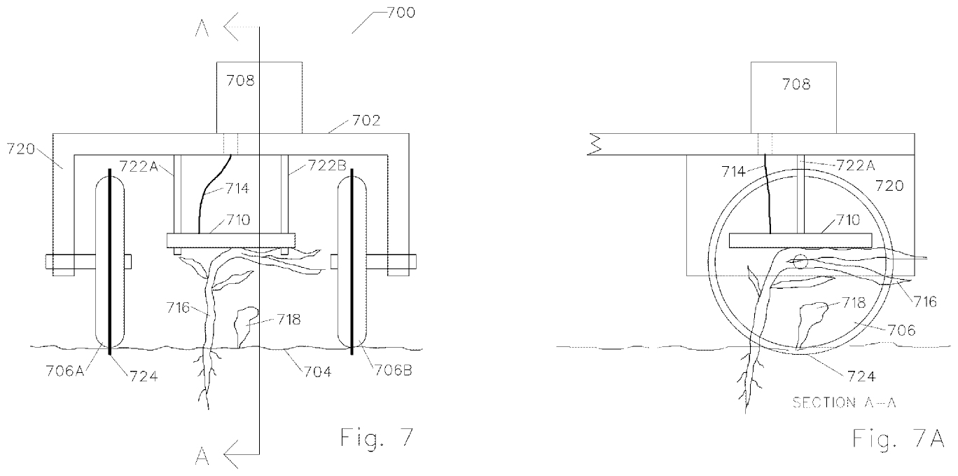

Description FIG. 7

FIG. 7 is an illustration 700 of towed vehicle 702 with a plant killing device 708 being pulled behind a tractor or other vehicle (not illustrated). In some applications the weeds stand out from crops 718 by height or position in the row, and the weed is susceptible to being killed by applying RF energy to the top of the weed. The plant killing device 708 has its ground lead connected to the metal chassis 720 of the towed vehicle and its hot lead 714 connected to a metal contactor plate 710 which contacts a weed 716. The RF energy passes from the contactor plate through the weed's stem 716 into the root to reach ground 704. A ground return to the chassis is supplied through metal wheels 706A and 706B. The wheels 706A and 706B may have ridges 724 or spikes or studs to improve electrical conductivity to the soil 704. Plant killing device 708 contains the RF generator, matching circuit, impedance measuring circuit, power supply and necessary switches. The probe in this embodiment is the metal contactor plate 710 which brushes against the above ground portion of a weed. Contactor plate 710 has an adjustable height from supports 722A and 722B. Metal wheels 706A and 706B provide grounding for the towed vehicle through the chassis.

Description FIG. 7A.

FIG. 7A is a section view of towed vehicle 702. It is generally desirable to keep the contactor plate just above the tallest crop 718. Since measured impedance through the contactor plate will vary with vehicle 702 travel, the match circuit may not be able to readjust fast enough, and a compromise match can be made. Operation is to first detect a weed making contact, apply RF power, and then remove power when the weed is no longer being contacted.

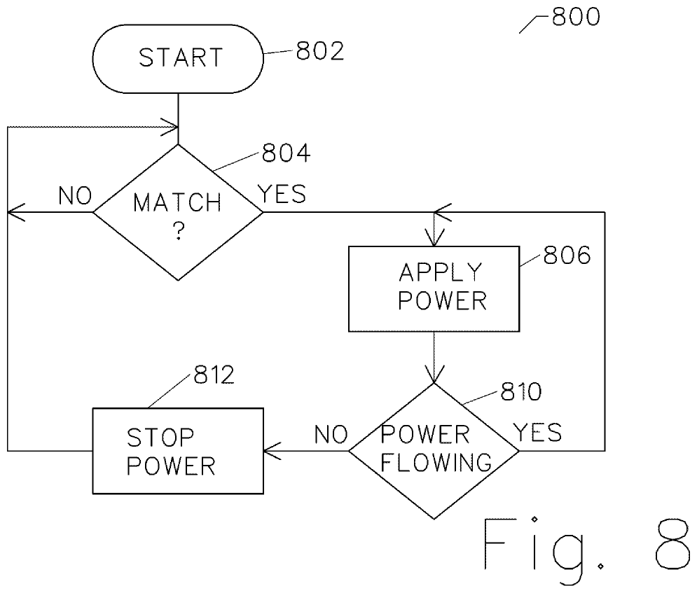

Description FIG. 8

FIG. 8 is a flow diagram 800. The plant killing device 708 may elect to apply RF power after it detects a suitable match by the impedance measuring circuit, and then cut power when it detects reflected energy increases, indicating the weed is no longer touching the contactor plate. In a first step 802 processing starts and in step 804 the impedance measuring circuit determines if a weed is contacting the contactor plate by measured impedance. If a suitable impedance match is measured, RF power is applied in step 806. While power is being delivered, the reflected power is monitored in step 810 to determine when the weed is no longer taking energy. When this condition is detected in step 812 the RF power is stopped and the impedance measuring circuit resume measurement in step 804.

Other anticipated variations and improvements.

1. The probe need not be fully inserted into the ground, particularly when the weed is not large or does not have a deep tap root.

2. Other probe designs are anticipated, including one with one or more missing periphery pins for avoiding ground contact with a flattened weed top. Another method to avoid wasting energy on a flattened weed top is to open-circuit a periphery pin from ground. That limits RF power application to only the root underground.

3. It is also possible to direct RF power in a specific direction and not other directions. For example, this could be done to protect crops. This can be accomplished again by open-circuiting periphery pins.

4. A probe may be designed with a round pinwheel to replace the single center pin and a pair of pinwheels on either side to replace the ground pins. Using pinwheels allow a continuous application of RF energy, or continuous contact without lifting the pinwheels out of the ground.

5. When the center pin is removed from the ground its temperature may be measured with a thermal camera or thermometer to see what temperature was achieved in a center hole or on the center pin.

6. The autonomous vehicle may use multiple arms with multiple probes for greater productivity.

7. Autonomous vehicle can also do other tasks, like pick up trash or other foreign, thin crops. It also works on insects, fungus, snails, caterpillars etc. Foreign material can be picked up with suction or other means.

8. A safety system is anticipated to detect pets or people in proximity, and to prevent physical harm or electrocution.

9. The frequency of the RF power source can be dynamically adjusted to make RF matching easier. For example, if more capacitive reactance is needed than available in the matching circuit, the frequency can be dropped. If more inductive reactance is needed than is available, the frequency can be increased. Likewise, the RF frequency can be adjusted for maximum productivity and power efficiency. Unintended radiation will be small because the probe is inserted into the soil, and the center pin is surrounded by grounded periphery pins. Also, the pins make poor antenna radiators because they are very short relative to a RF wavelength.

10. The camera can also inspect the probe for damage for or for needing cleaning. The arms can cause lift the probe causing the insulating plate to retract, cleaning the pins.

11. The autonomous vehicle may use tracks, like a bulldozer, instead of wheels for better traction over soft ground.

12. Killing the weed in not always necessary. Less than lethal power delivery can achieve a desired result, such as the weed not producing seeds. Again, this method is to reduce treatment time and reduce energy relative to what is required for weed killing.

13. Testing has revealed that sometimes impedance will change while cooking a weed. This could be caused, for example, by the production of steam. If a change is noted in monitored delivered power or reflected power, a readjustment of the matching circuit may be performed.

What I claim is:

1. A plant killing system for killing a plant comprised of a RF generator whose output is connected to an input of a matching circuit, and output of the matching circuit that is connected to a soil probe, wherein the generator applies sufficient RF energy to the soil probe to kill the plant.

2. A system according to claim 1 where the impedance measuring circuit is connected to the input of the matching circuit and the output of the matching circuit is connected to the probe, to determine adjustments to the matching circuit.

3. A system according to claim 1 wherein the ground probe is inserted into a plant in the soil.

4. A system according to claim 1 wherein RF energy delivered is modified by increasing RF power output from the RF generator.

5. A system according to claim 1 wherein the operating frequency of RF generator is changed.

6. A system according to claim 1 wherein said plant development is impaired but the plant is not killed.

7. A system according to claim 1 wherein plant killing apparatus is transported by an autonomous vehicle.

8. A system according to claim 1 wherein the correctness of said matching is statistically verified.

9. A system according to claim 1 wherein RF generator shutdown protection is applied by detecting reflected energy.

10. A system according to claim 1 wherein post application soil or probe temperature is measured to determine energy delivery.

11. A system according to claim 1 wherein the characteristic impedance of said RF generator is lower than the characteristic impedance at the input of the matching circuit.

12. A system according to claim 1 wherein matching circuit may be either TEE, PI, or L-section.

13. A system according to claim 1 wherein matching circuit is adjusted by stepper motors.

14. A system according to claim 1 wherein matching circuit is modified by switching inductors or capacitors.

15. A system according to claim 1 wherein power application is modified depending on plant size and plant type.

16. A system according to claim 1 wherein probe insertion depth is modified depending on plant size and plant type.

17. A system according to claim 1 wherein RF energy delivered is modified by increasing or decreasing power application time multiplied by power delivered.

18. A towed system according to claim 1 wherein the RF energy is applied while a weed is detected and removed while a weed is not detected.

19. A method for killing plants comprised of inserting a soil probe into a plant, matching an impedance of the soil probe with a matching circuit to a RF generator, then applying sufficient RF energy to kill said plant.

20. A method according to claim 19 where energy delivery is monitored during application.
